(19) United States
(12) Patent Application Publication
(10) Pub. No.: US 2020/0277111 A1
(43) Pub. Date: Sep. 3, 2020

(54) One Piece Oversize Tab Closure

(71) Applicants: Robert Joseph Borse, Plainfield, IL (US); Michael Rae Borse, Western Springs, IL (US); Joseph Jude Borse, Chicago, IL (US)

(72) Inventors: Robert Joseph Borse, Plainfield, IL (US); Michael Rae Borse, Western Springs, IL (US); Joseph Jude Borse, Chicago, IL (US)

(21) Appl. No.: 16/232,459

(22) Filed: Dec. 26, 2018

(51) Int. Cl. B65D 47/08; B29C 51/26

(52) U.S. Cl. CPC B65D 47/0852; B29L 2031/565; B29C 51/266

(57) ABSTRACT

A one piece oversize tab closure and process for manufacturing thereof is described. The tab trim process includes punching, cutting, pre-positioning the plastic with cylinder or mechanical rocking levers, or using heating to flex the plastic for trimming and repositioning the tab. By heating or flattening the tab or window, the size of the tab is larger relative to the size of the window of the closure.

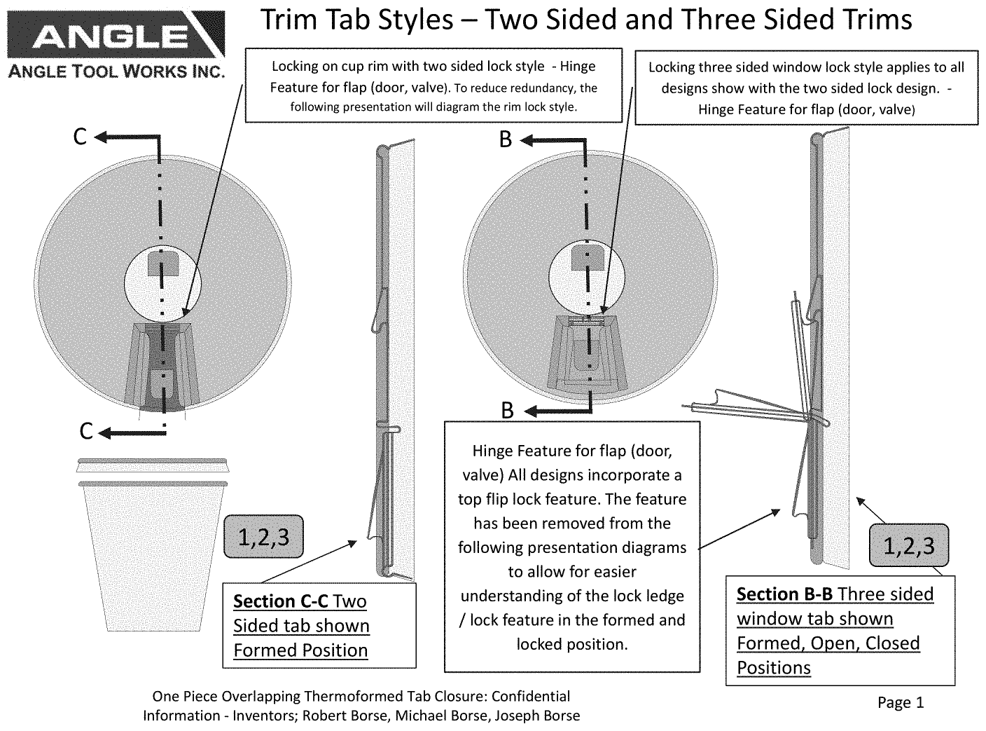

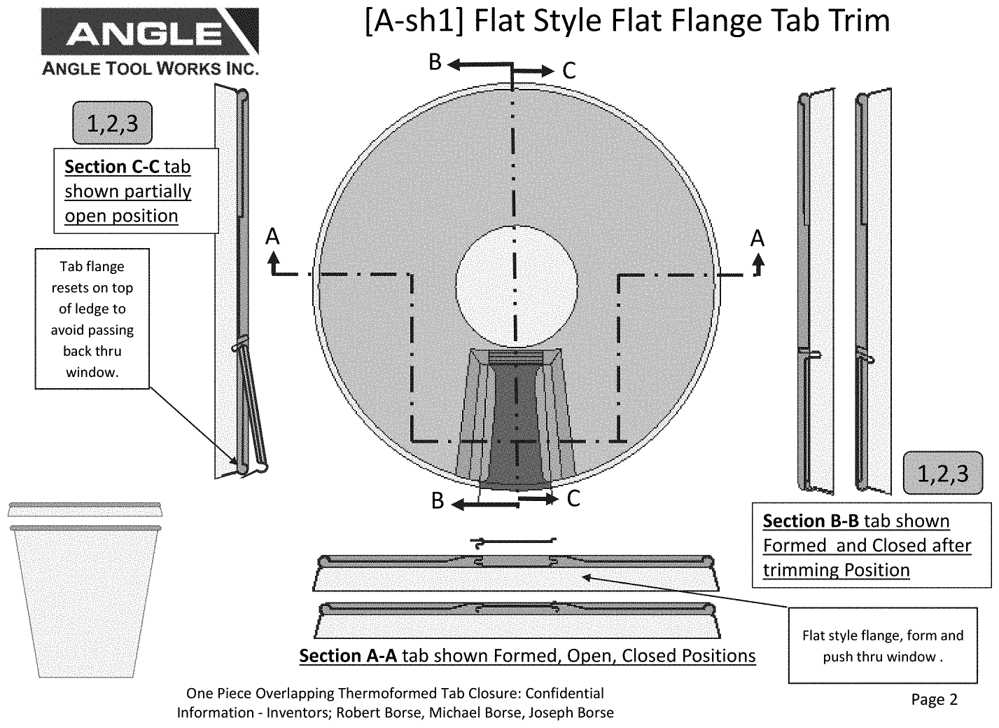

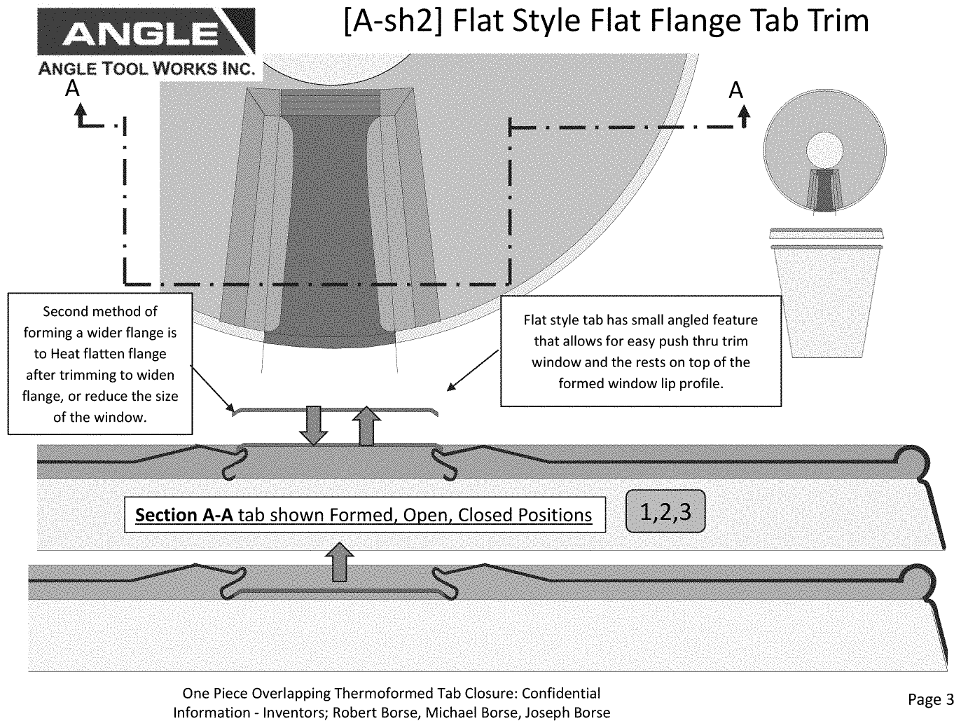

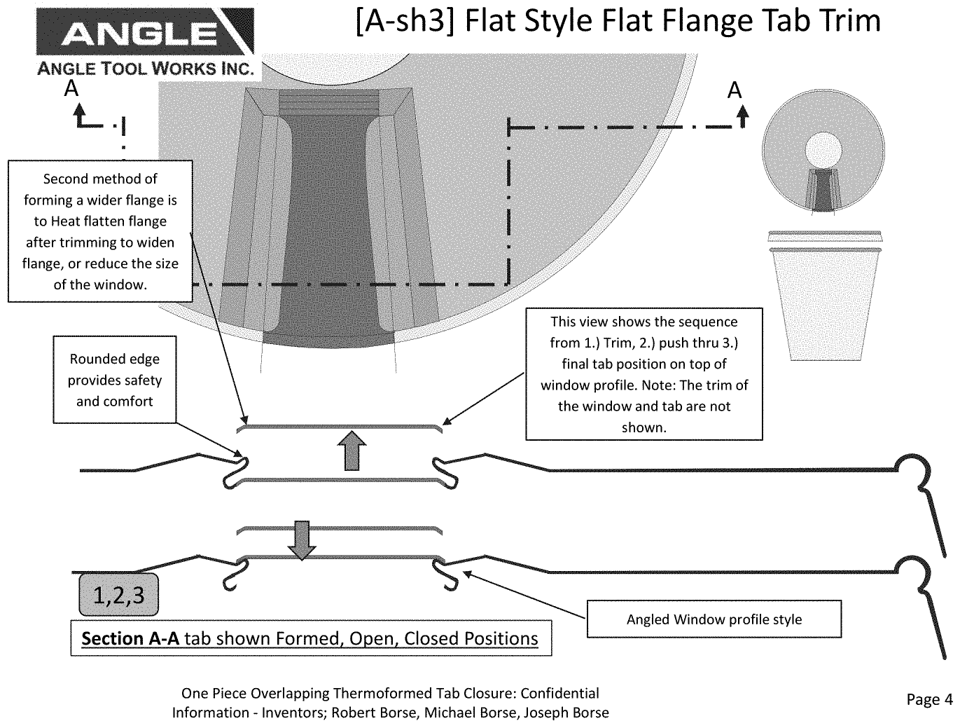

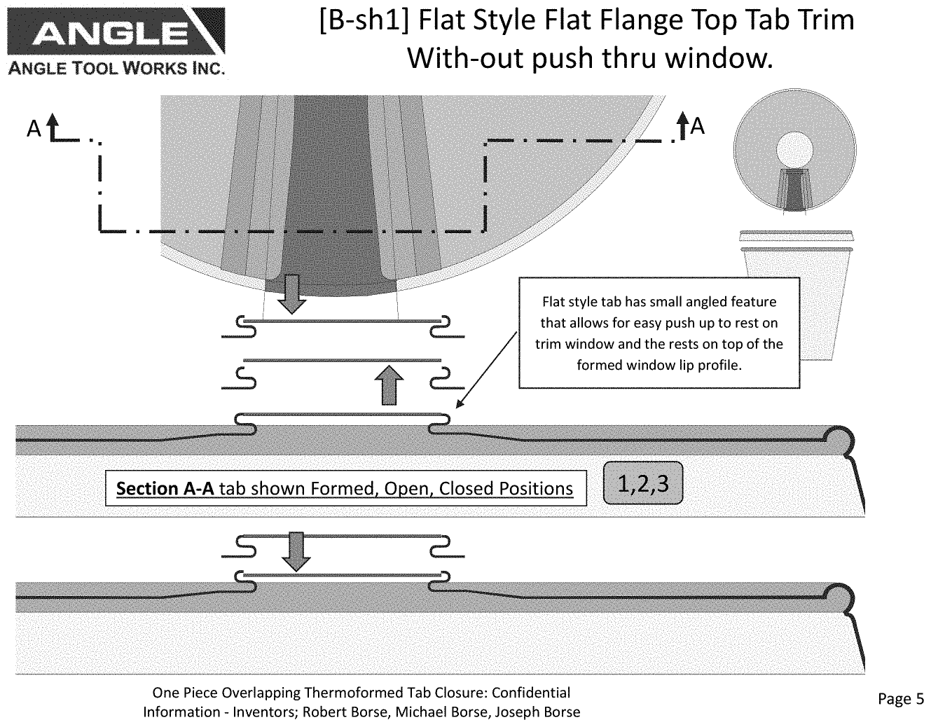

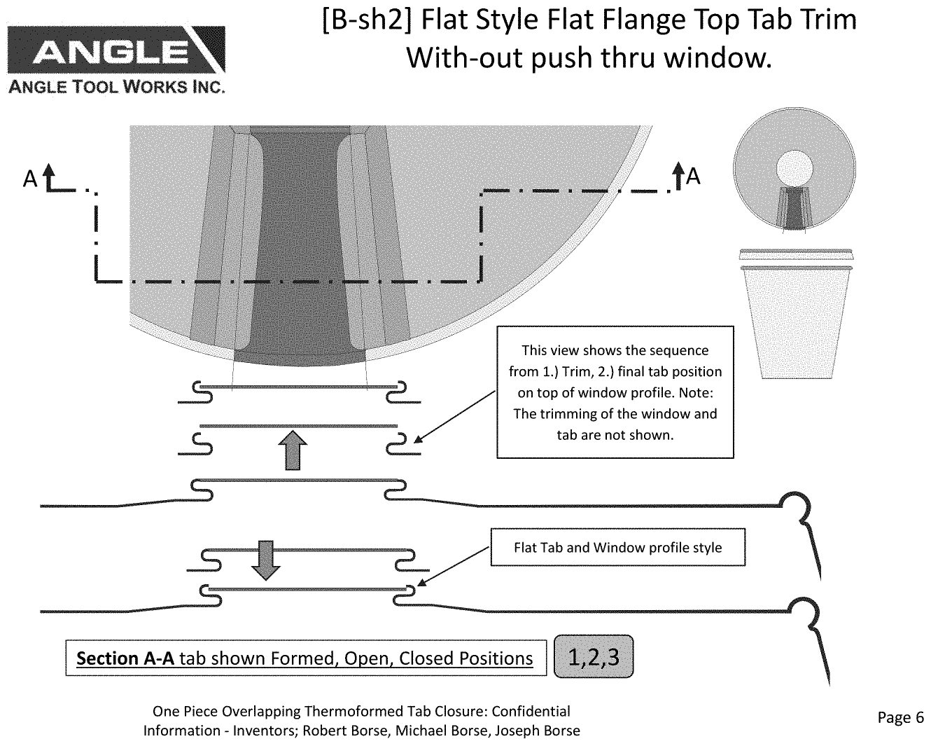

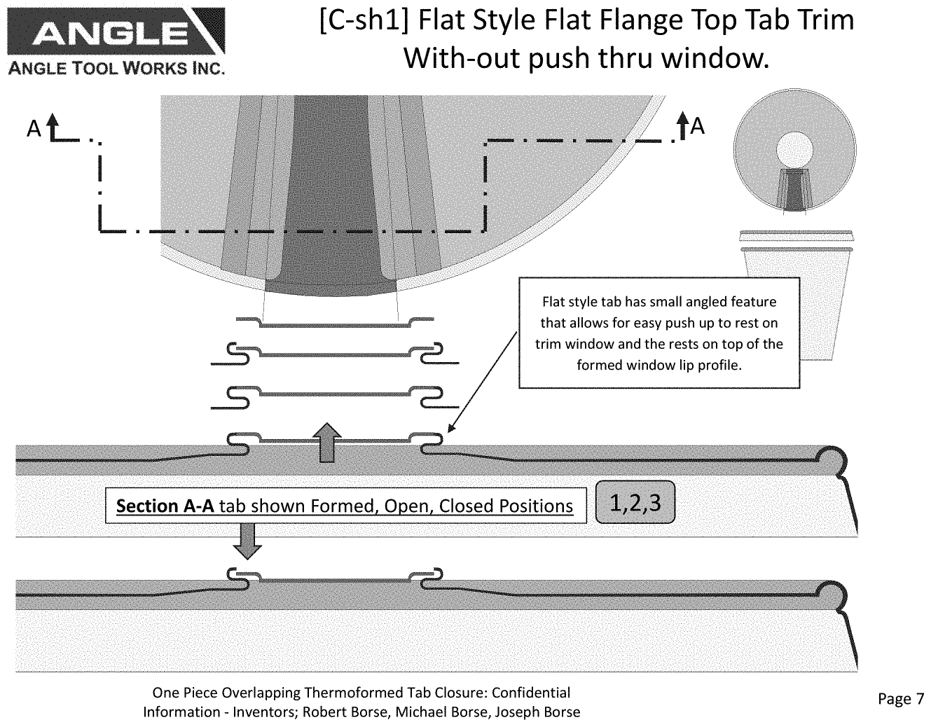

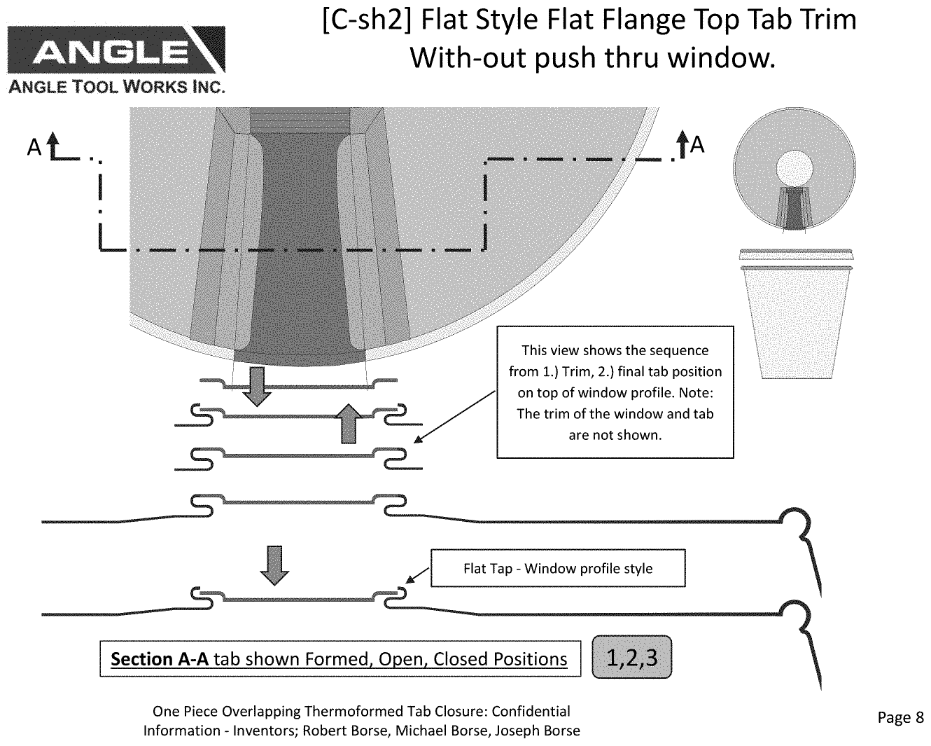

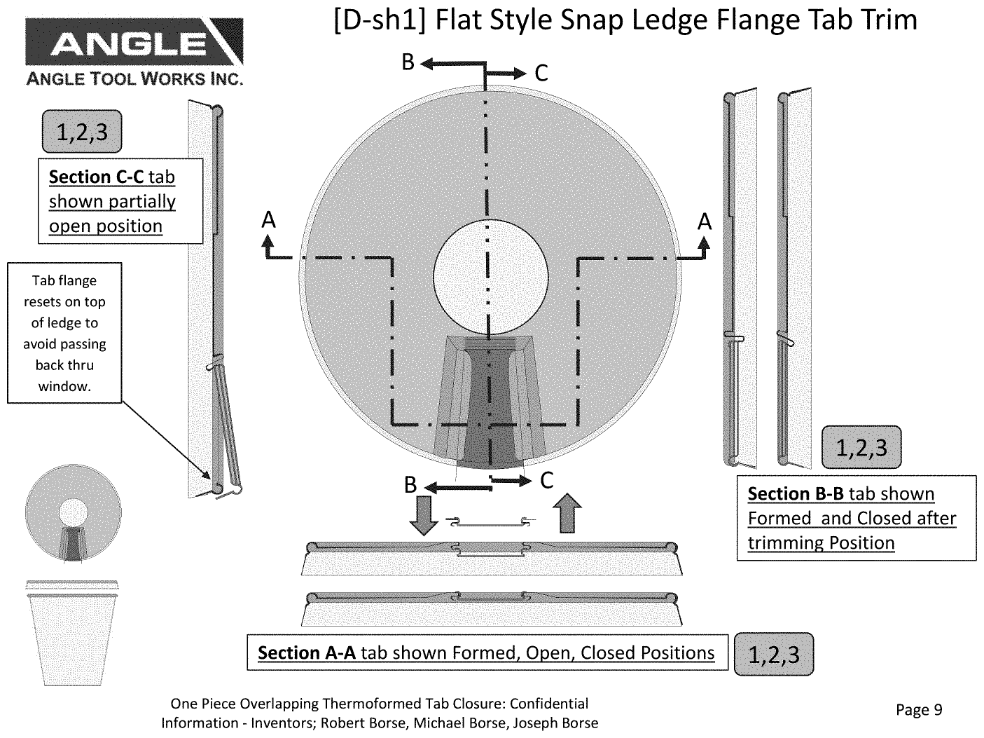

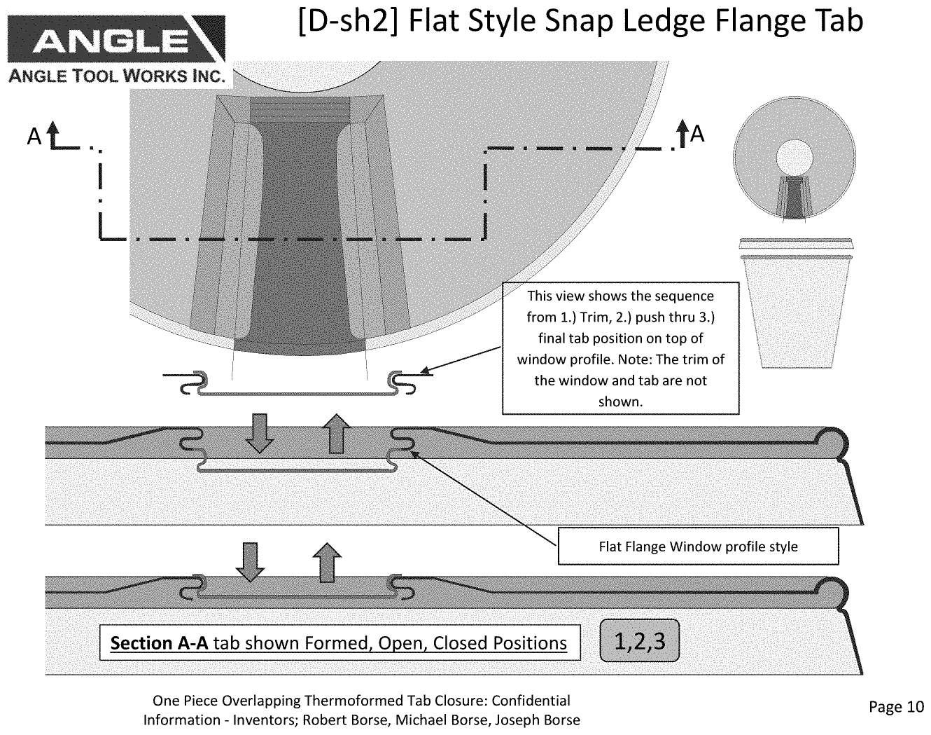

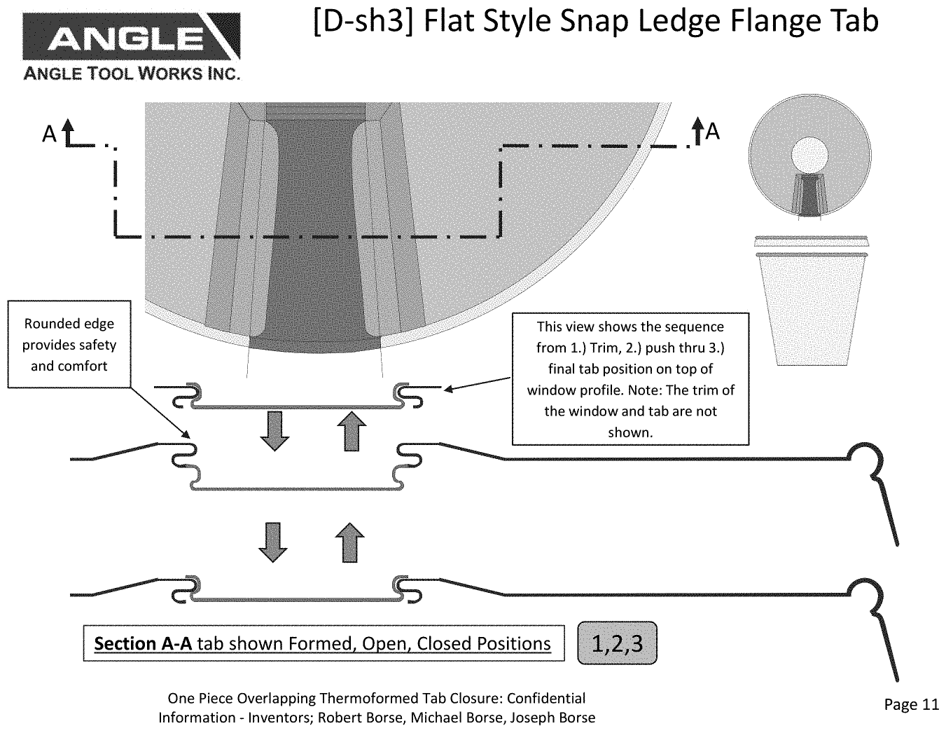

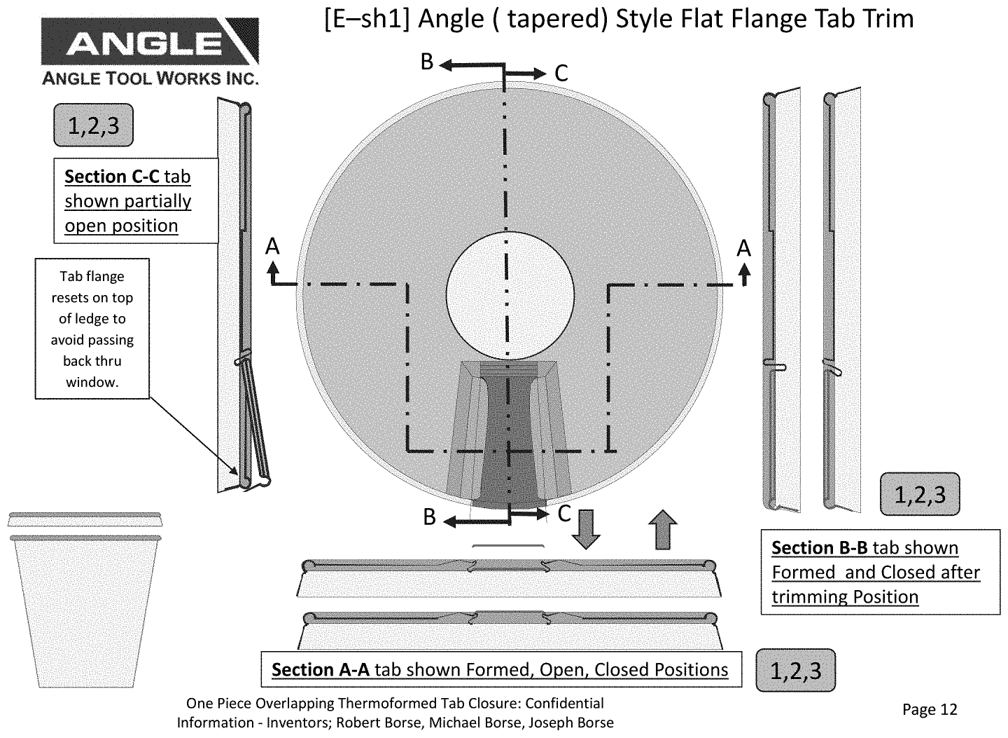

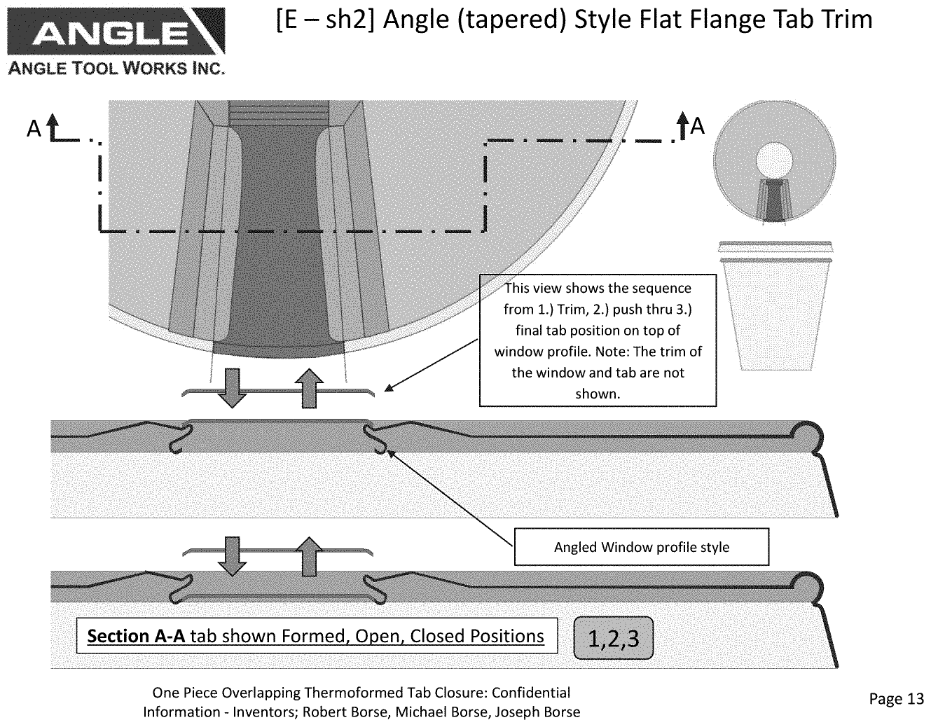

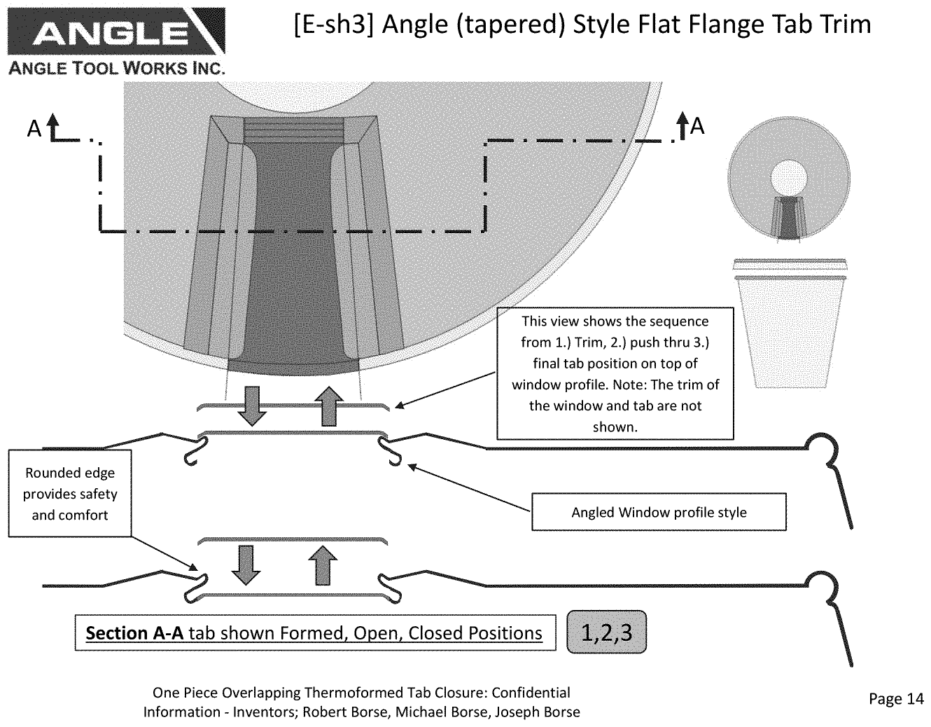

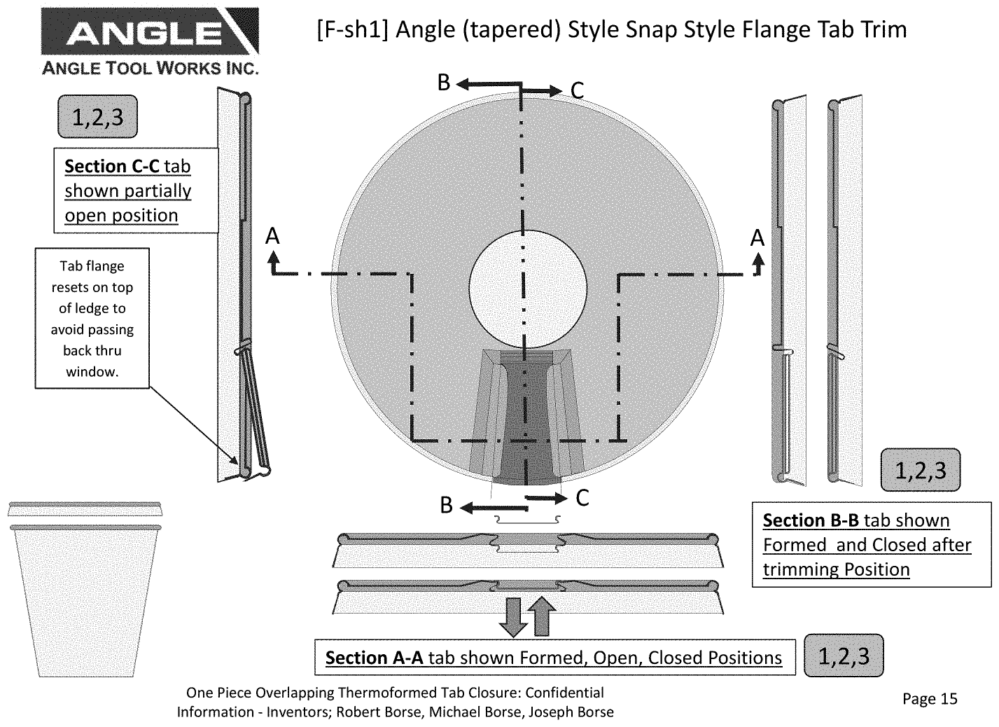

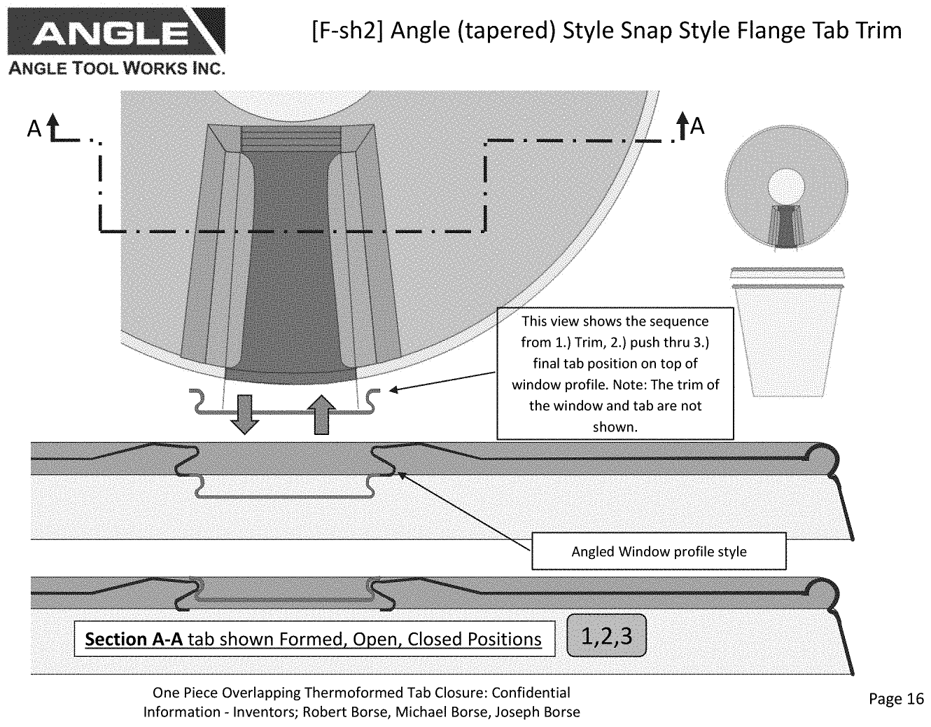

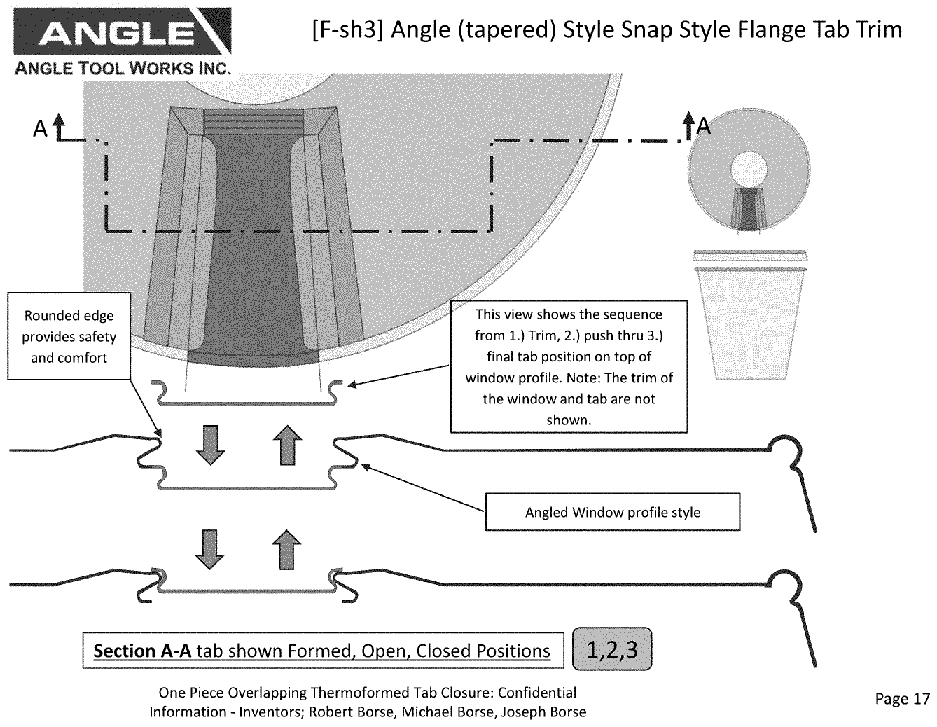

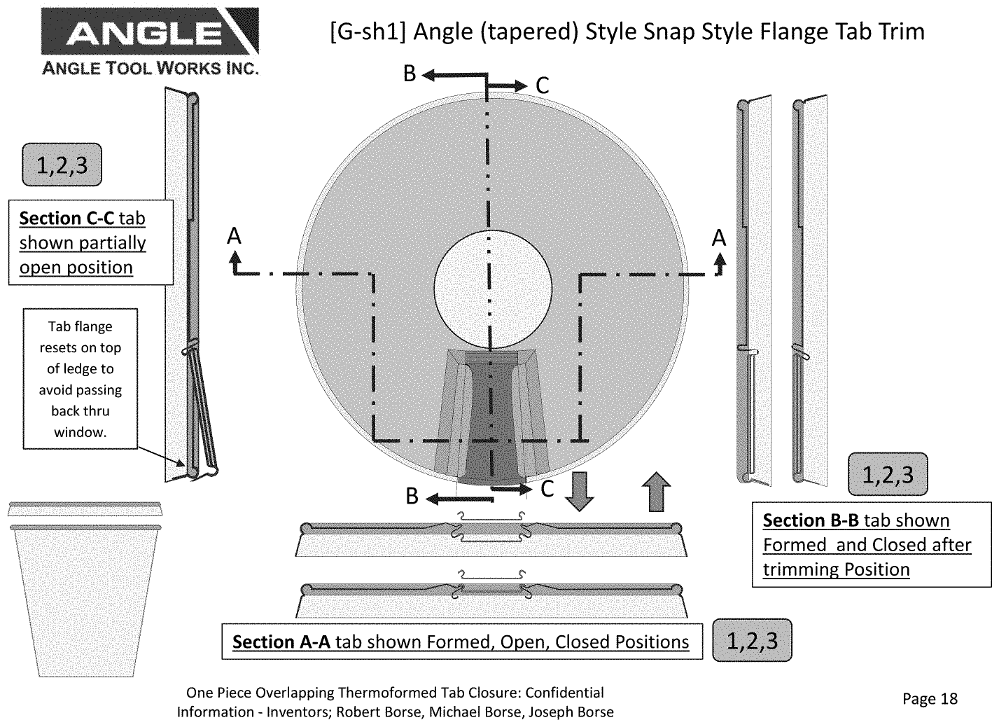

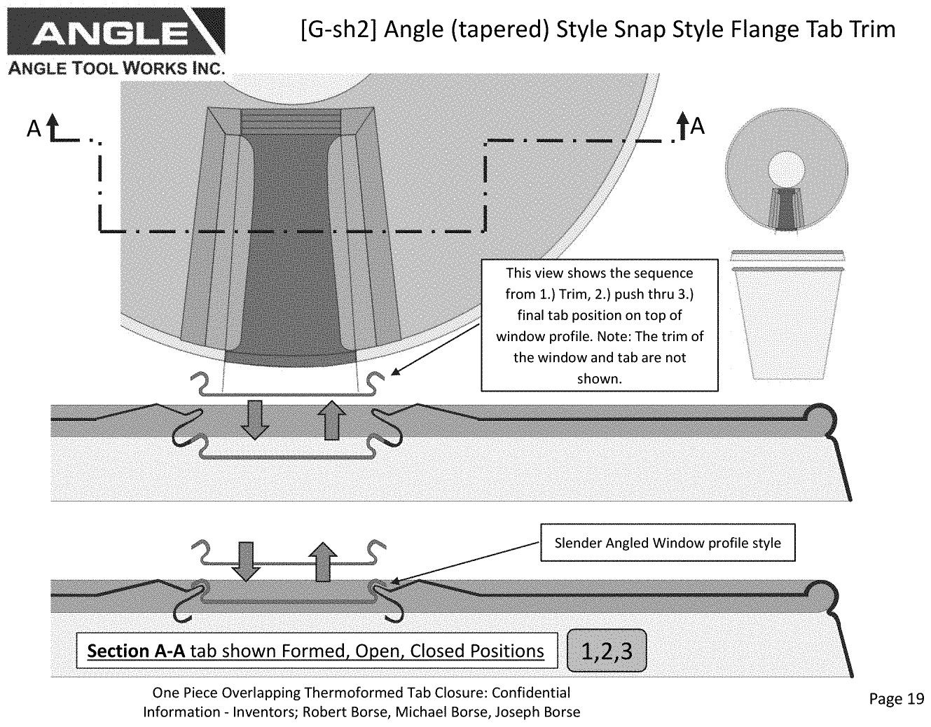

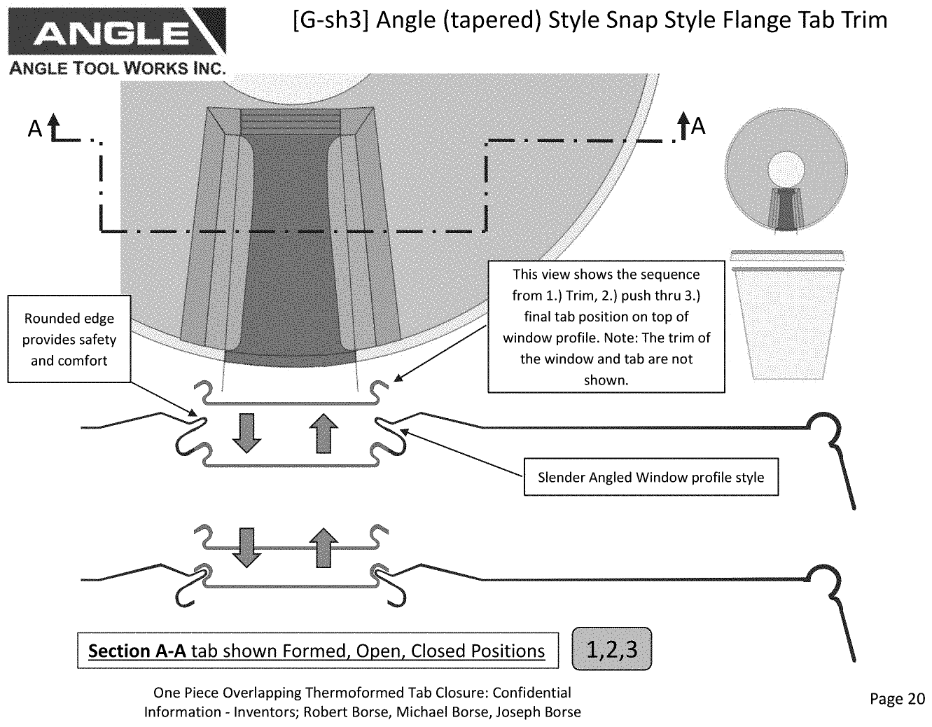

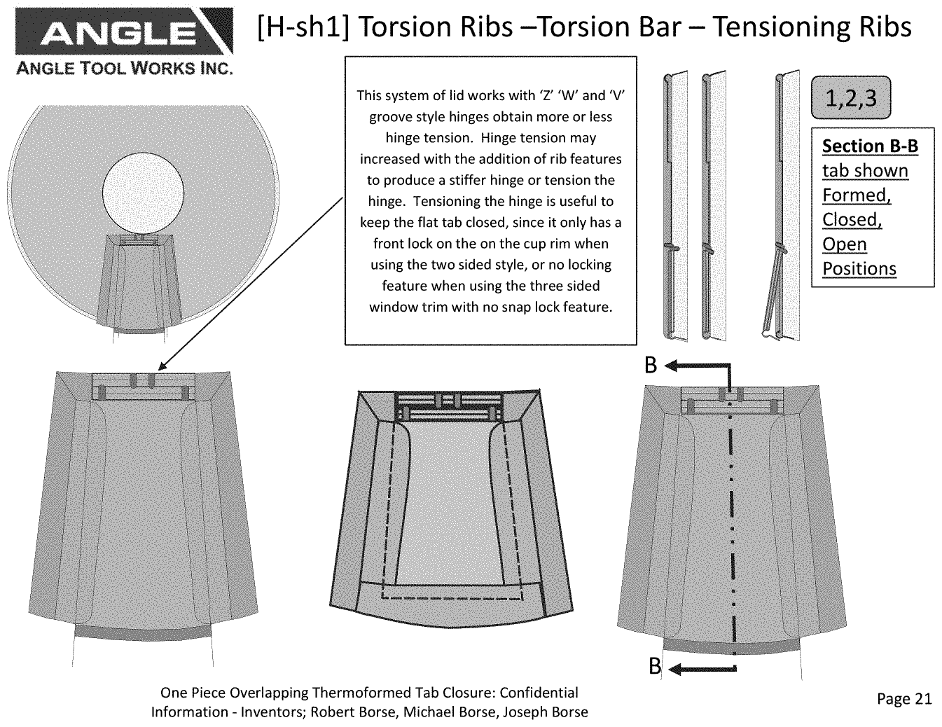

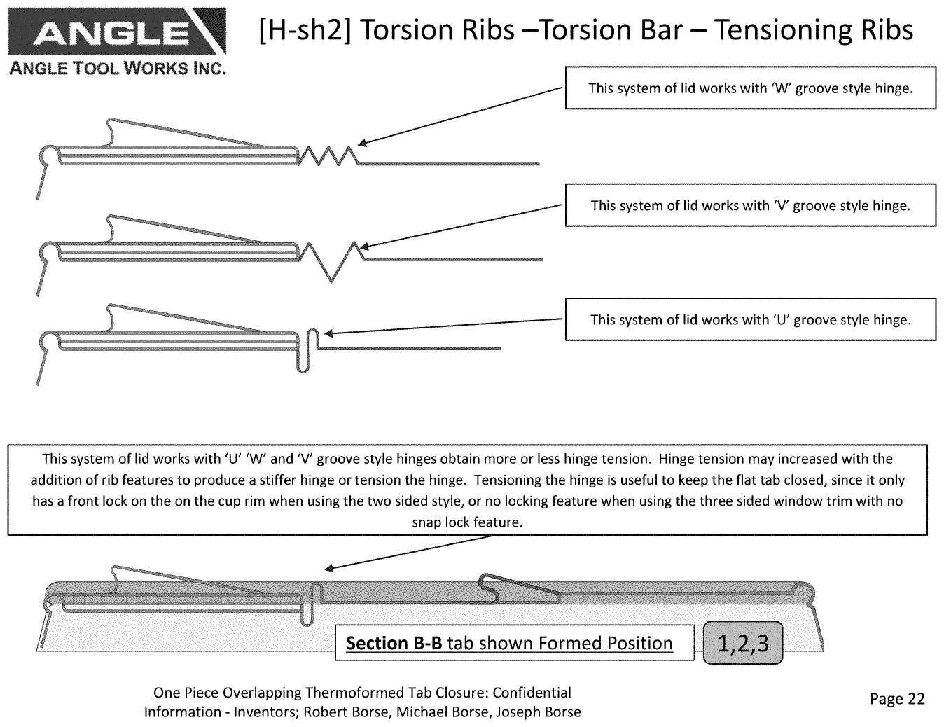

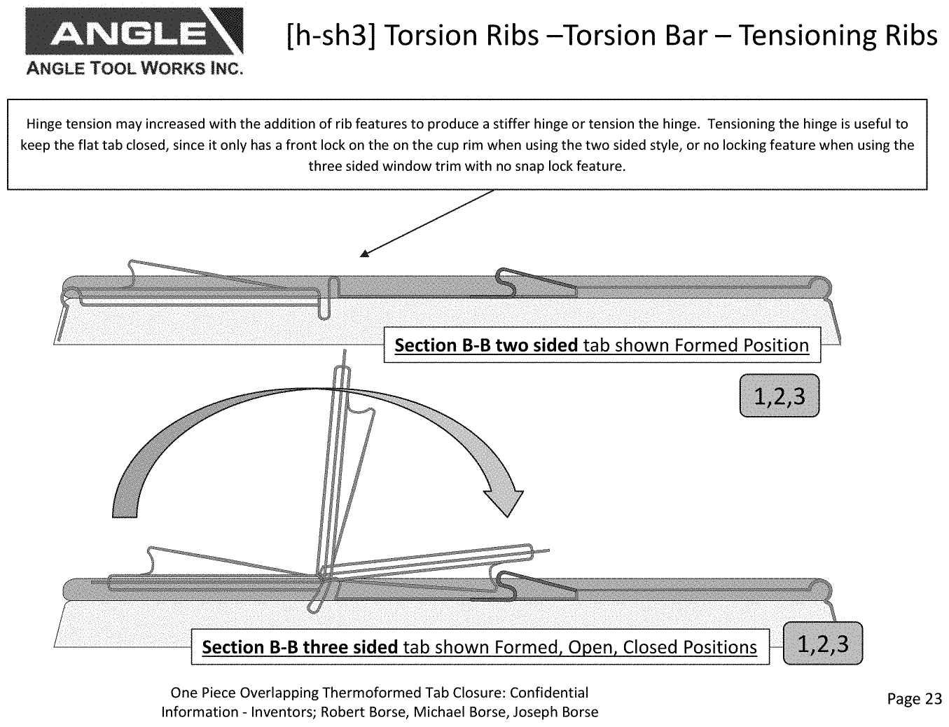

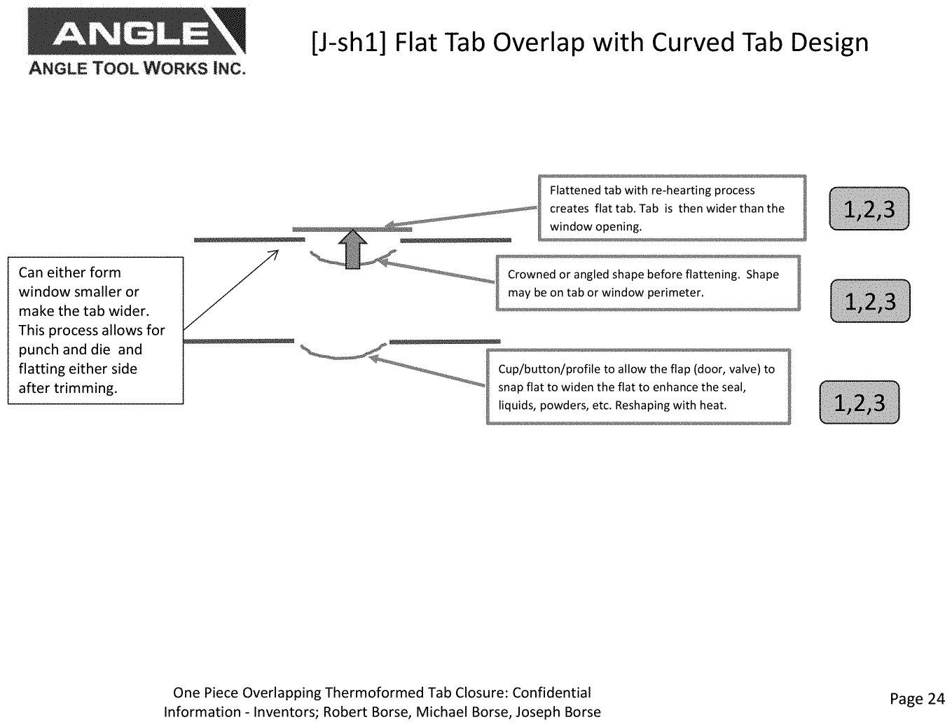

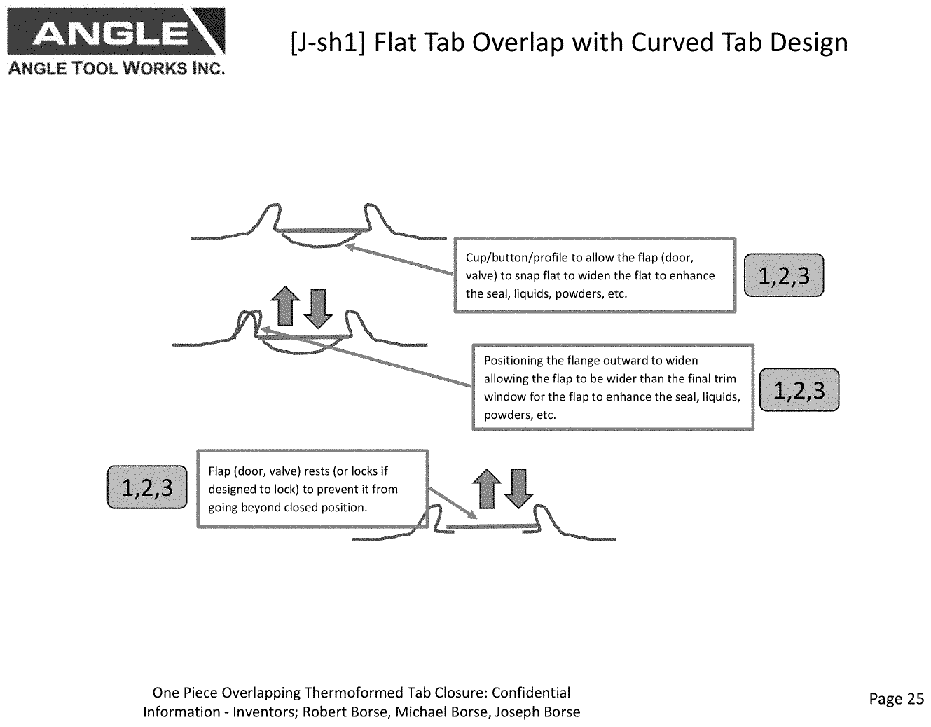

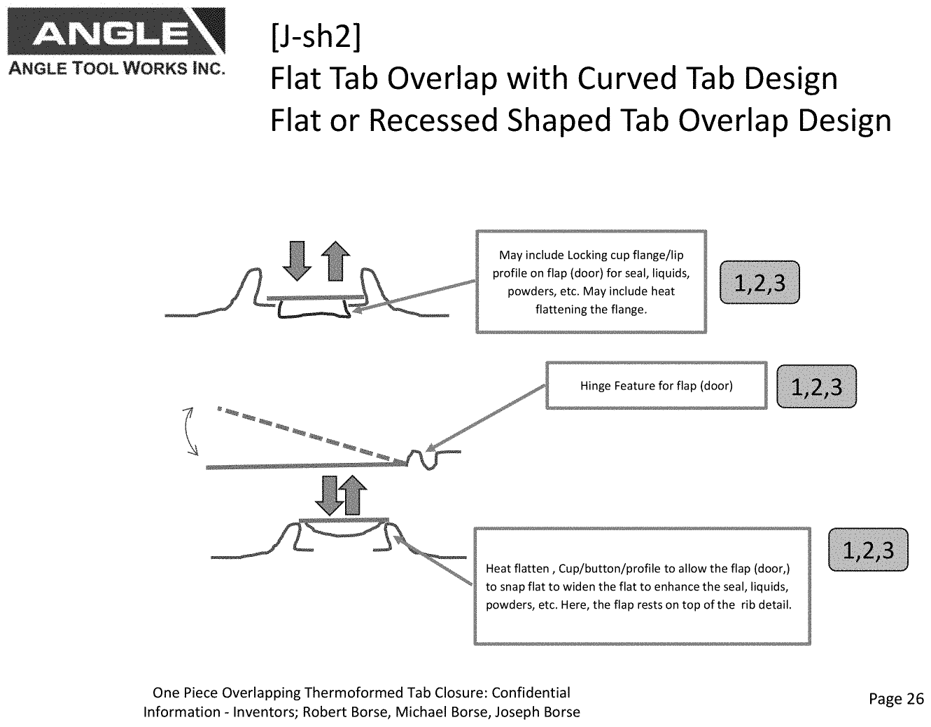

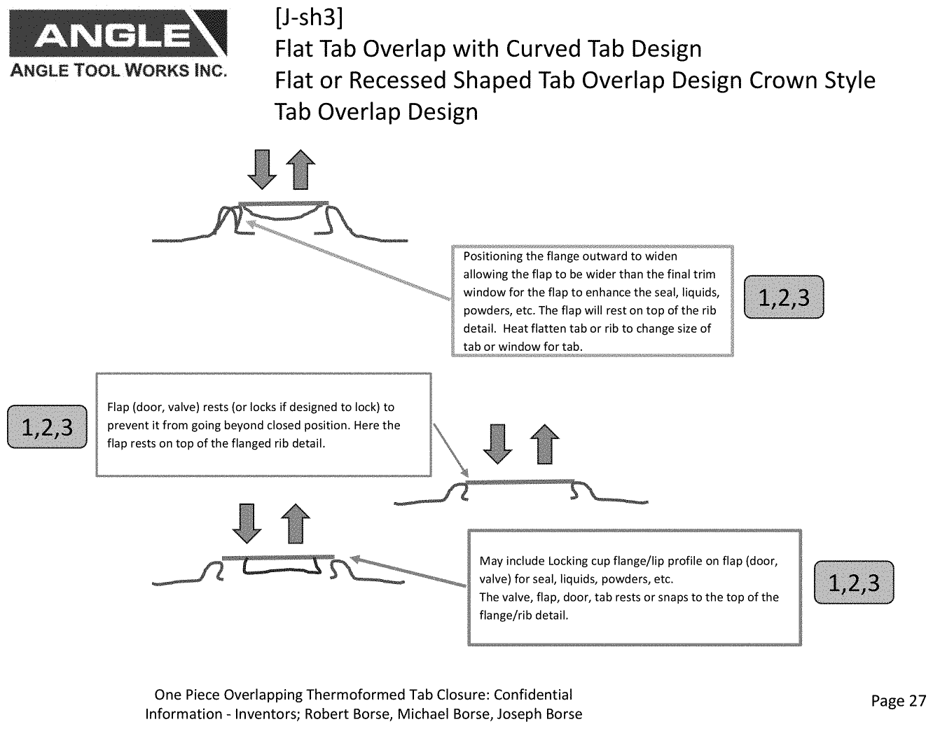

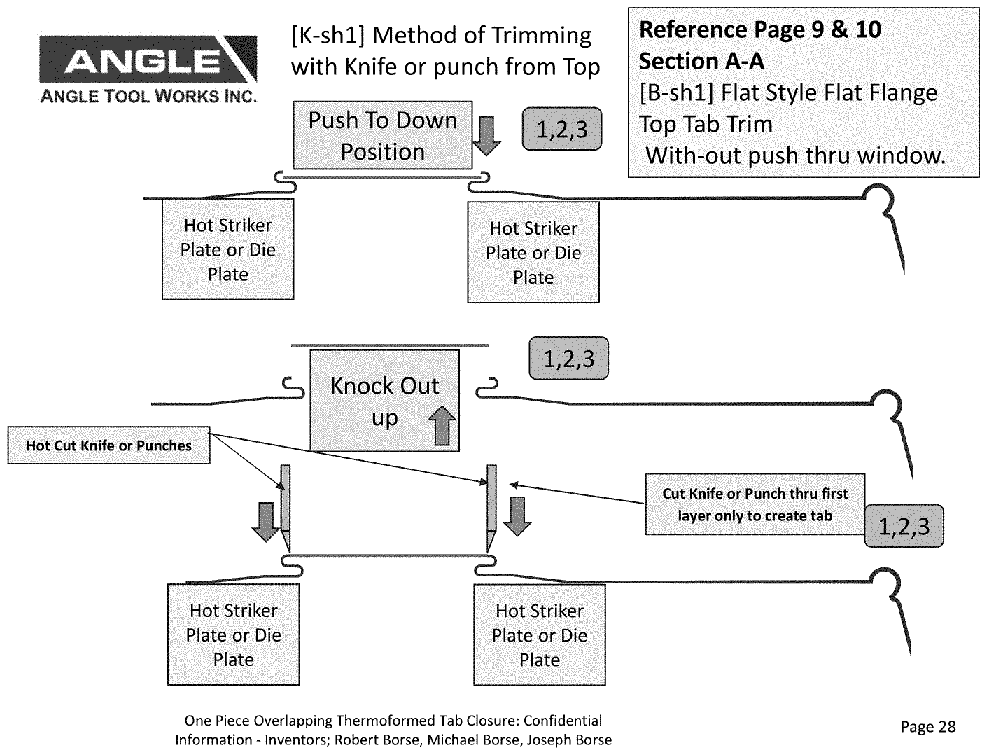

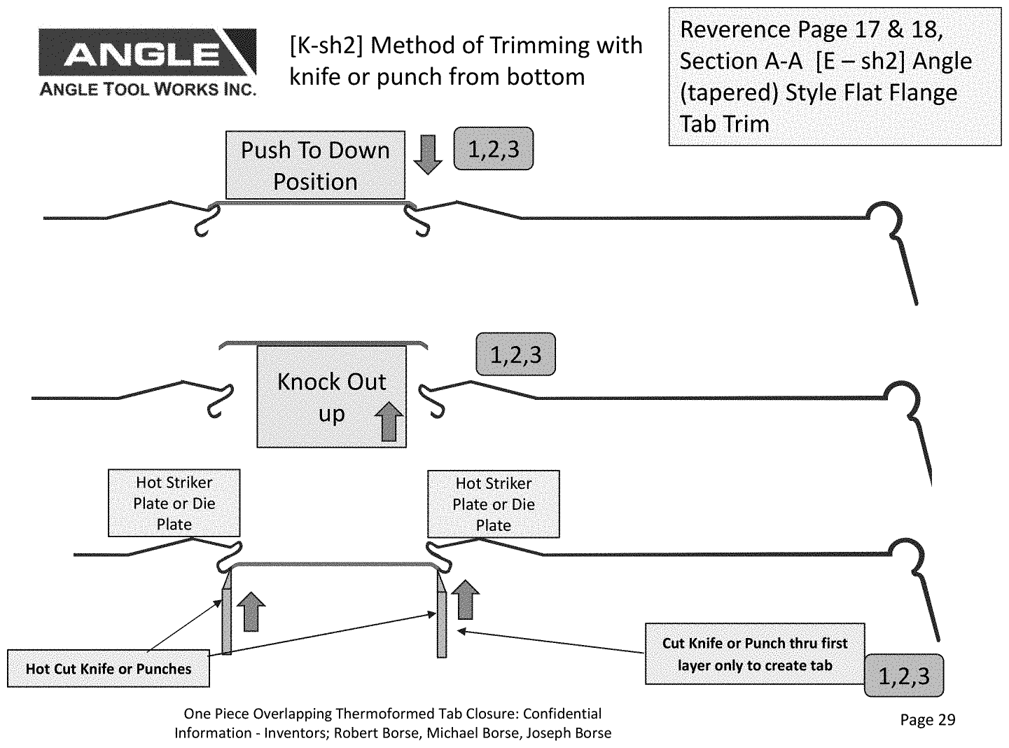

### BACKGROUND OF THE INVENTION

The present invention relates to a tab as part of a closure for a container. The tab includes an overlapping flange manufactured as a one piece thermoformed product. Advantages of such a tab design include the economies of production as a one piece tab and lid with overlap with is adaptable to other types of storage and container products. The design is compatible with such products as coffee cup lids, all types of packaging containers that need a lid feature.

### SUMMARY

A cup or container tab with an overlapping flange manufactured as a one piece thermoformed product is described herein. The design may include a ledge for the trimmed tab to rest against when it returns to its formed position or re-positioned tab position after trimming. The tab design would incorporate a hinge to allow the tab to pivot open and then return the formed position or re-positioned on top of the ledge, using the memory of the plastic. The trimmed tab is able to be opened and closed. The push thru tab allows for user friendly rounded edges at the window for safe sipping/drinking without the risk of cutting a user's lip.

A method of manufacturing such a tab as part of a lid is also described herein. The tab trim process includes punching, cutting, pre-positioning the plastic with cylinder or mechanical rocking levers, or using heating to flex the plastic for trimming and repositioning the tab. By heating and flattening the tab or window, the size of the tab relative the window is altered.

### BRIEF DESCRIPTION OF THE DRAWINGS

The Figures generally disclose two tab trim styles—two sided and three sided tab trims.

Figure A-sh1 illustrates a flat style flat flange tab trim.

Figure A-sh2 illustrates a flat style flat flange tab trim.

Figure A-sh3 illustrates a flat style flat flange tab trim.

Figure B-sh1 illustrates a flat style flat flange top tab trim without push thru window.

Figure B-sh2 illustrates a flat style flat flange top tab trim without push thru window.

Figure C-sh1 illustrates a flat style flat flange top tab trim without push thru window.

Figure C-sh2 illustrates a flat style flat flange top tab trim without push thru window.

Figure D-sh1 illustrates a flat style snap ledge flange tab trim.

Figure D-sh2 illustrates a flat style snap ledge flange tab.

Figure D-sh3 illustrates a flat style snap ledge flange tab.

Figure E-sh1 illustrates an angle (tapered) style flat flange tab trim.

Figure E-sh2 illustrates an angle (tapered) style flat flange tab trim.

Figure E-sh3 illustrates an angle (tapered) style flat flange tab trim.

Figure F-sh1 illustrates an angle (tapered) style snap style flange tab trim.

Figure F-sh2 illustrates an angle (tapered) style snap style flange tab trim.

Figure F-sh3 illustrates an angle (tapered) style snap style flange tab trim.

Figure G-sh1 illustrates an angle (tapered) style snap style flange tab trim.

Figure G-sh2 illustrates an angle (tapered) style snap style flange tab trim.

Figure G-sh3 illustrates an angle (tapered) style snap style flange tab trim.

Figure H-sh1 illustrates torsion ribs, torsion bar, and tensioning rib style hinges.

Figure H-sh2 illustrates torsion ribs, torsion bar, and tensioning rib style hinges.

Figure H-sh3 illustrates torsion ribs, torsion bar, and tensioning rib style hinges.

Figure J-sh1 illustrates a flat tab overlap with curved tab design.

Figure J-sh2 illustrates a flat tab overlap with curved tab design and flat or recessed shaped tab overlap design.

Figure J-sh3 illustrates a flat tab overlap with curved tab design and flat or recessed shaped tab overlap design crown style tab overlap design.

Figure K-sh1 illustrates a method of trimming with knife or punch from top.

Figure K-sh2 illustrates a method of trimming with knife or punch from bottom.

### DETAILED DESCRIPTION

The tab trim disclosed herein may have a variety of design variations. The figures and description thereof are intended to demonstrate some of the variations possible. Some manufacturing considerations include material selections to determine overlap and snap details. Materials may vary between PET, PP, PE, Styrene, RPET, etc. The material gage and variation thereof may determine overlap. Thicker, thinner, and other materials may determine the limits of the product manufacturing. Another design consideration is the various tensioning ribs disclosed.

Two sided and three sided trims are disclosed herein. The two sided lock style includes a locking feature on the cup rim or ledge. The two sided lock style also includes a hinge feature for flap (door, valve). The hinge feature for flat (door, valve) may also include top flip lock feature. The top flip lock feature has been removed from some figures for easier understanding of the lock ledge/lock feature in the formed and locked positions. The three sided window lock style does not lock to the cup rim or ledge. Aspects of the two sided lock style may also be part of the three sided window locks style, and vice versa.

Figure A-sh1 illustrates a flat style flat flange tab trim. Figure A-sh1 is an example of the two sided lock style trim that locks to a ledge or rim of the cup on a third side. As shown in section A-A, the tab may be formed as part of the lid, and then punched through, creating a window in the lid. Section B-B shows the tab in the formed position and then in the closed position after trimming. Section C-C shows the tab in a partially open position. The tab flange may rest on the top of the ledge of the cup in order to not pass back through the window.

Figure A-sh2 also illustrates the flat style flat flange tab trim. As shown in Section A-A, the tab is in a formed position and then pushed through into an open position, and then back in a closed position where the edge rests on top of the formed window. The flat style tab has small angled feature that allows for easy push through trim window and then rests on top of the formed window lip profile. One method of forming a wider flange is to heat flatten flange after trimming to widen flange, or reduce the size of the window.

Figure A-sh3 illustrates the flat style flat flange tab trim. Figure A-sh3 shows the sequence from (1) trim, (2) push thru, (3) final tab position on top of window profile. The window may include a rounded edge that provides safety and comfort. As illustrated, the window may have an angled profile style.

Figure B-sh1 illustrates a flat style flat flange top tab trim without push thru window. As shown in Figure B-sh1, the flat style tab has small angled feature that allows for each push up to rest on the trim window and then rests on the top of the formed window lip profile. The tab is depicted as formed, then open, and closed positions.

Figure B-sh2 also illustrates the flat style flat flange top tab trim without push thru window. Figure B-sh2 shows the sequence from (1) trim, (2) final tab position on top of window profile. The window and tab have a flat profile style in Figure B-sh2.

Figure C-sh1 illustrates a flat style flat flange top tab trim without push thru window. As shown in Figure C-sh1, the flat style tab has small angled feature that allow for easy push up to rest on trim window and then rests on top of the formed window lip profile.

Figure C-sh2 illustrates the flat style flat flange top tab trim without push thru window. Figure C-sh2 further shows the sequence (1) trim, (2) final tab position on top of window profile. The window and tab have a flat profile style.

Figure D-sh1 illustrates a flat style snap ledge flange tab trim. Section A-A depicts the tab in formed, open, and closed positions. Section B-B depict the tab shown in the formed position and then in the closed position after trimming. Section C-C shows the tab in a partially open position. The tab flange may rest on top of ledge to avoid passing back thru the window.

Figure D-sh2 also illustrates the flat style snap ledge flange tab. Figure D-sh2 shows the sequence from (1) trim, (2) push thru, and (3) final tab position on top of the window profile. A flat flange window profile style is depicted in Figure D-sh2.

Figure D-sh3 also illustrates the flat style snap ledge flange tab. Section A-A shows the tab in the formed, open, and closed positions. Additionally, Figure D-sh3 shows that the window may include a rounded edge for safety and comfort. Figure D-sh3 shows the sequence from (1) trim, (2) push thru, and (3) final tab position on top of window profile.

Figure E-sh1 illustrates an angle (tapered) style flat flange tab trim. Section A-A shows the tab in a formed, open, and closed positions. Section B-B shows the tab in the formed position, and then in the closed position after trimming. Section C-C shows the tab in a partially open position. The tab flange may rest on top of the ledge to avoid passing back thru window.

Figure E-sh2 also illustrates the angle (tapered) style flat flange tab trim. As shown, this view shows the sequence from (1) trim, (2) push thru, and (3) final tab position on top of window profile. Also shown is the angled window profile style.

Figure E-sh3 also illustrates the angle (tapered) style flat flange tab trim. This view shows the sequence from (1) trim, (2) push thru, (3) final tab position on top of the window profile. Also shown is a rounded edge that provides safety and comfort and an angled window profile style.

Figure F-sh1 illustrates an angle (tapered) style snap style flange tab trim. Section A-A shows the tab in the formed, open and closed positions. Section B-B shows the tab in the formed position and in the closed position after trimming. Section C-C shows the tab in a partially open position. The tab flange may rest on the ledge to avoid passing through the window.

Figure F-sh2 also illustrates the angle (tapered) style snap style flange tab trim. The view in Figure F-sh2 shows the sequence from (1) trim, (2) push thru, and (3) final tab position on top of the window profile. Section A-A also shows the tab in the formed, open and closed positions. Another angled window profile style is depicted in Figure F-sh2.

Figure F-sh3 also illustrates the angle (tapered) style snap style flange tab trim. This figure shows the sequence from (1) trim, (2) push thru, and (3) final tab position on top of the window profile. Also depicted are the rounded edge of the window and the angled window profile style.

Figure G-sh1 illustrates an angle (tapered) style snap style flange tab trim. Section A-A shows the tab in the formed, open and closed positions. Section B-B shows the tab in the formed position and in the closed position after trimming. Section C-C shows the tab in a partially open position. The tab flange may rest on the ledge to avoid passing through the window.

Figure G-sh2 also illustrates the angle (tapered) style snap style flange tab trim. As shown, another window profile is depicted, this one with a slender angled window profile style. The view in Figure G-sh2 shows the sequence from (1) trim, (2) push thru, and (3) final tab position on top of the window profile.

Figure G-sh3 also illustrates the angle (tapered) style snap style flange tab trim. G-sh3 shows the sequence from (1) trim, (2) push thru, and (3) final tab position on top of the window profile. This figure also shows a rounded edge for safety and comfort as well as a slender angled window profile style.

Figure H-sh1 illustrates torsion ribs, torsion bar, and tensioning rib style hinges. The system of lids disclosed work with “Z” “W” “U” and “V” groove style hinges to obtain more or less hinge tension. Hing tension may increase with the addition of rib feature to produce a stuffer hinge or tension the hinge. Tensioning the hinge is useful to keep the flat tab closed, since it only has a front lock on the cup rim when using the two sided style, or no locking feature when using the three sided window trim with no snap lock feature.

Figure H-sh2 also illustrates torsion ribs, torsion bar, and tensioning rib style hinges. Figure H-sh2 depicts examples lids with W, V, and U groove style hinges. This system of lid works with “U” “W” and “V” groove style hinges that obtain more or less hinge tension. Hinge tension may increase with the addition of rib feature to produce a stiffer hinge or tension the hinge. Tensioning the hinge is useful to keep the flat tab closed, since it only has a front lock on the cup rim when using the two sided style, or no locking feature when using the three sided window trim with no snap lock feature. Section B-B shows the tab in the formed position.

Figure H-sh3 illustrates torsion ribs, torsion bar, and tensioning rib style hinges. Section B-B of the two sided tab is shown in the formed position, while Section B-B of the three sided tab is shown in the formed, open, and closed positions. Hinge tension may increase with the addition of rib features to produce a stiffer hinge or tension the hinge. Tensioning the hinge is useful to keep the flat tab closed, since it only has a front lock on the cup rim when using the two sided style, or no locking feature when using the three sided window trim with no snap lock feature.

Figure J-sh1 illustrates a flat tab overlap with curved tab design. The tab may originally be curved, crowned or angled in shape before flattening. The shape may be on tab or window perimeter. Then the tab is flattened with reheating process that creates a flat tab. The tab is then wider than the window opening. The tab may have a cup or button profile in the formed position to allow the flap to widen to flat to enhance the seal, preventing liquids, powders, etc. from passing through the window. Some instances involve flattening or widening the tab, while others may the window smaller. In some examples, a flange of the window is position outward to widen. In a closed position, the flap (door, valve) rests (or locks if designed to lock) to prevent it from going beyond the closed position.

Figure J-sh2 illustrates the flat tab overlap with curved tab design and flat or recessed shaped tab overlap design. As shown, the flat tab design may include locking cup flange/lip profile on flap for seal, liquids, powders, etc. In order to seal, the overlap design may include heat flattening the flange. The tab design may also include a hinge feature for flap (door). The manufacturing process may include heat flattening a cup/button/profile to allow the flap (door) to snap flat to widen the flat to enhance the seal, liquids, powders, etc. As depicted, the flap rests on top of the rib detail.

Figure J-sh3 illustrates a flat tab overlap with curved tab design and flat or recessed shaped tab overlap design crown style tab overlap design. This figure shows positioning the flange outward to widen allowing the flap to be wider than the final trim window for the flap to enhance the seal, liquids, powders, etc. The flap will rest on top of the rib detail. Heat flatten tab or rib to change the seize of the tab or window for tab. Flap (door, valve) rests (or locks if designed to lock) to prevent it from going beyond closed position. As depicted in this figure, the flap rests on top of the flanged rib detail. The design may include locking cup flange/lip profile on flap for seal, liquids, powders, etc. The valve, flap, door, tab rests or snaps to the top of the flange/rib detail.

Figure K-sh1 illustrates a method of trimming with knife or punch from top. Starting at the bottom of the figure, hot strike plates or die plates along with hot cut knife or punches trim the formed lid to create the tab. Then the tab is knocked out upwards. In some examples, after being knocked out upwards, the tab may be flattened or widened. Then the tab is pushed down to position.

Figure K-sh2 illustrates a method of trimming with knife or punch from bottom. Figure K-sh2 is similar to K-sh1, but the tab is cut from the bottom, pushed up through the window, and then pushed back down to position where the tab rests and/or locks on top of the window profile shown.

1. A cup or container tab with an over lapping flange manufactured as a one piece thermoformed product.

2. (canceled)

3. The cup or container tab of claim 1, further comprising: a ledge for the tab to rest after the tab is trimmed when the tab returns to a formed position or re-positioned tab position.

4. The cup or container tab of claim 1, further comprising: a hinge to allow the tab to pivot open and then return to a formed position or re-positioned on top of a ledge.

5. The cup or container of claim 1, wherein after trimming the tab, the trimmed tab is able to be opened or closed.

6. The cup or container tab of claim 1, further comprising: a rounded edge at a window in the one piece thermoformed product.

7. The cup or container tab of claim 1, wherein when in a closed position, the tab may be designed to be spill resistant.

8. (canceled)

9. The cup or container tab of claim 1, wherein the tab includes a flat flange.

10. The cup or container tab of claim 1, further comprising: a crown or button shape that allows the tab to flatten and widen during/after trimming process.

11. (canceled)

12. (canceled)

13. A method, comprising:
forming a thermoformed product;
trimming a tab from the thermoformed product to create a window opening in the thermoformed product, wherein the tab pivots between an open and a closed position after trimming; and
flattening the tab such that the tab overlaps the window opening.

14. A method, comprising:
forming a thermoformed product;
trimming a tab from the thermoformed product to create a window opening in the thermoformed product, wherein the tab pivots between an open and a closed position after trimming; and
punching the tab through the window opening, wherein when in the closed position the tab rests on edges of the window opening.
